(19) United States
(12) Patent Application Publication
(10) Pub. No.: US 2003/0133364 A1
(43) Pub. Date: Jul. 17, 2003

(54) Rocking display device

(75) Inventors: Michael T. Merk, Bay Village, OH (US); John R. Nottingham, Hunting Valley, OH (US); John W. Spirk, Gates Mills, OH (US); Dennis M. Futo, Clevaland, OH (US); Wing Yen, Kowloon (HK); Melvin Lai, Kowloon (HK)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(73) Assignee: Thoughtworks Ltd., Cleveland, OH

(21) Appl. No.: 10/053,383

(22) Filed: Jan. 17, 2002

(51) Int. Cl. G04B 37/00

(52) U.S. Cl. 368/276

(57) ABSTRACT

An apparatus includes a changing image and an information display. A shaped base portion, having a length less than a height of the apparatus, supports the image and the information display in a substantially vertical orientation. The shaped base portion permits the image and the information display to oscillate upon external urging. Added weight in the top half of the apparatus assists in providing a desired oscillation rate.

### BACKGROUND OF THE INVENTION

The present invention relates to clocks and other display devices. It finds particular application in conjunction with desktop sized displays and will be described with particular reference thereto. It is to be appreciated however, that the invention may find further application in larger and smaller devices having a variety of display characteristics.

Conventionally, clocks and other information display devices are fairly static in nature. Indeed, this is a desirable characteristic in that stationary devices are easier to read.

Moreover, image display devices also tend to be limited to the display of a single, static image. While some effort has been directed toward the display of more than one image using a lenticular lens or rotating panels, conventional systems require the motion of a passer-by or internal mechanical oscillations to alternate the images.

### SUMMARY OF THE INVENTION

The present invention overcomes problems in the prior art and others.

In accordance with one aspect of the present invention, an apparatus includes an image and an information display. A shaped base portion, having a length less than a height of the apparatus, supports the image and the information display in a substantially vertical orientation. The shaped base portion permits the image and the information display to oscillate upon external urging.

In accordance with another aspect of the present invention, the information display includes a timepiece, such as a digital or analog clock and the like.

In accordance with another aspect of the present invention, the apparatus further includes a power supply which provides operative power solely to the timepiece. Timepiece includes such things as the timekeeping mechanism or circuit, the display, alarms, buzzers, or other perceptible events indicative of the alarm and the like.

In accordance with another aspect of the present invention, the image includes a first image and a second image. A mechanism is also included which displays one of the first and second images depending on a position of oscillation of the shaped base portion.

In accordance with another aspect of the present invention, the mechanism includes an array of lenticular lenses.

In accordance with another aspect of the present invention, the shaped base portion includes less than half the weight of the apparatus.

In accordance with another aspect of the present invention, a clock includes a frame having a top half and a bottom half, the top half including more than fifty percent of the total weight of the clock, the bottom half including a rounded base which permits the frame to rock when urged from a static position. A time indicating display and an image display are disposed within the frame and are viewable by an observer. The image display alternates between at least two images as the frame rocks.

In accordance with another aspect of the present invention, the clock further includes an alarm settable to sound at a determined time and immediately upon user interaction.

In accordance with another aspect of the present invention, following an urge from the static position, the rocking dampens towards the static position.

In accordance with another aspect of the present invention, a changing display includes a frame with opposing sides where the upper side includes a weight which concentrates a higher percentage of weight toward the top of the display. The display also includes a first image and a second image supported upright in the frame. An image selection mechanism permits viewing of one of the first and second images depending on the viewing angle. Also included is a non-powered rocking base which supports the display and permits the viewing angle to change relative to a stationary observer.

In accordance with another aspect of the present invention, the changing display further includes an information display supported by the frame. The information display includes clock displays, temperature displays, scrolling or static alphanumeric displays, and the like.

In accordance with another aspect of the present invention, the changing display further includes a power supply used to power the information display. Power supplies are any presently known and yet discovered sources of power sufficient to operate the information display such as battery power, solar power, and the like.

Still further advantages and aspects of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is a perspective view of a display apparatus which suitably practices the present invention;

FIG. 2 is an enlarged cross-sectional view of a changing image display which suitably practices the present invention;

FIG. 3 is a side perspective view of the apparatus illustrated in FIG. 1;

FIG. 4 is a rear perspective view of the apparatus illustrated in FIG. 1;

FIG. 5 is a series of side elevational views illustrating motion of the device; and

FIG. 6 is a series of front elevational views corresponding to the positions illustrated in FIG. 5.

### DETAILED DESCRIPTION OF THE PREFERRED EMBODIMENTS

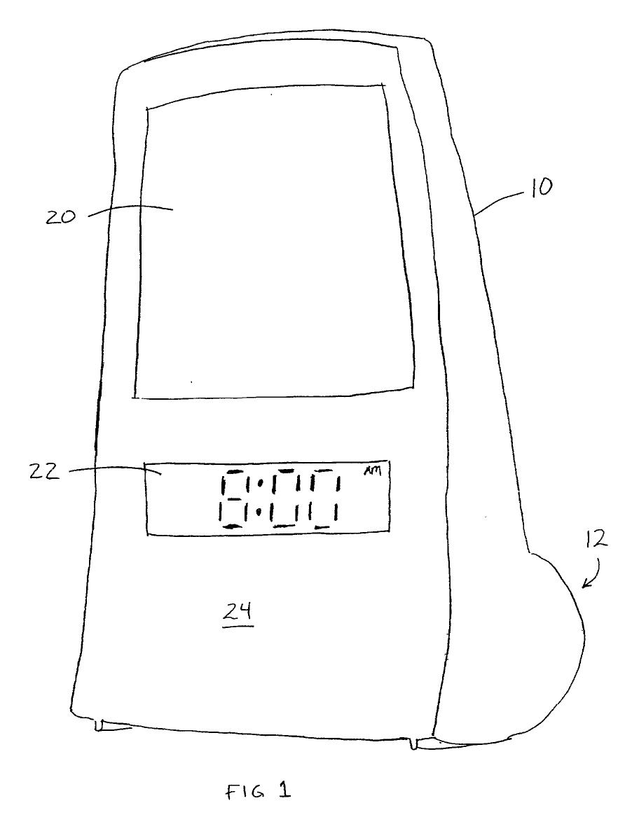

With reference to FIG. 1, a display device includes a frame or housing 10 supported on a shaped base 12. In the illustrated embodiment, base 12 defines a rounded bottom shape which rests on a surface. Also, as can be appreciated by reference to the figure, the length of the rounded base is less than the height of the device in the upright position desirably minimizing desk space or surface area which the device occupies in use. It is to be appreciated however, that in alternate embodiments, a longer base may function as well. Continued reference to FIG. 1 shows the device also includes an image display area 20 and an information display area 22. In the illustrated embodiment, an area 24 of the frame 10 remains for the application of logos, decals, trademarks and the like. In alternate embodiments, the information display 22 may be enlarged to include additional or substitute information such as temperature, alternate time zones, scrolling messages, and the like. In yet further alternate embodiments, the image display area may be enlarged or shaped differently to accommodate a variety of variously shaped devices.

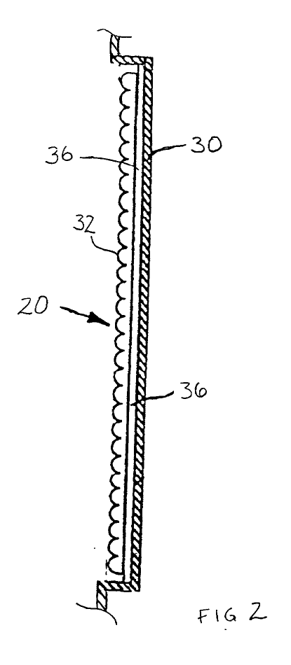

With reference now to FIG. 2, there is seen an image display 20 for displaying two or more consecutively changing images to be viewed by a stationary viewer. Image display 20 includes a back panel 30 behind an array of lenses 32. The lenses can be arranged to form a horizontally extending array, or can constitute an array of a honeycomb, spherical, or other known lenticular arrangements. Disposed between the back panel 30 and the lens array 32, there is disposed a static image carrier 36. In the illustrated embodiment, the image carrier 36 is in the form of a sheet or film having on one or two of its surfaces, a plurality of printed images in a manner known, for example from U.S. Pat. Nos. 5,100,330; 5,488,451; 5,695,346; 6,226,906 incorporated for their teachings here by reference, or by any other method in the future developed. Those of ordinary skill in the art will recognize that the optical principle on which such methods are based is the ability to make visible each one of the multiple images printed on the image carrier 36 depending on a viewing angle. In the presently preferred embodiment, the lenticular lens is adhered directly to the surface of the image carrier and the combination is affixed to the back panel 30 of frame 10.

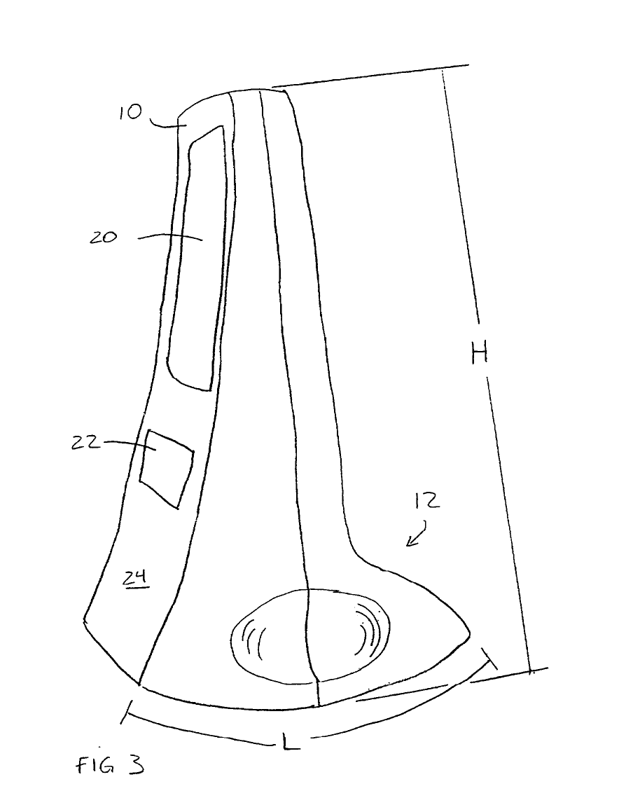

With reference now to FIG. 3, the device 10 has a shaped base 12 defining a length L. The device also defines a height H where L<H. In the presently preferred embodiment, length L is approximately half of height H. To achieve an appropriate rocking speed, extra weight is included in the upper half of the frame 20. In one embodiment, extra weight is fitted to the inside top edge of the frame and can include other materials such as metal and the like, or additional frame material extending into the inside of the frame.

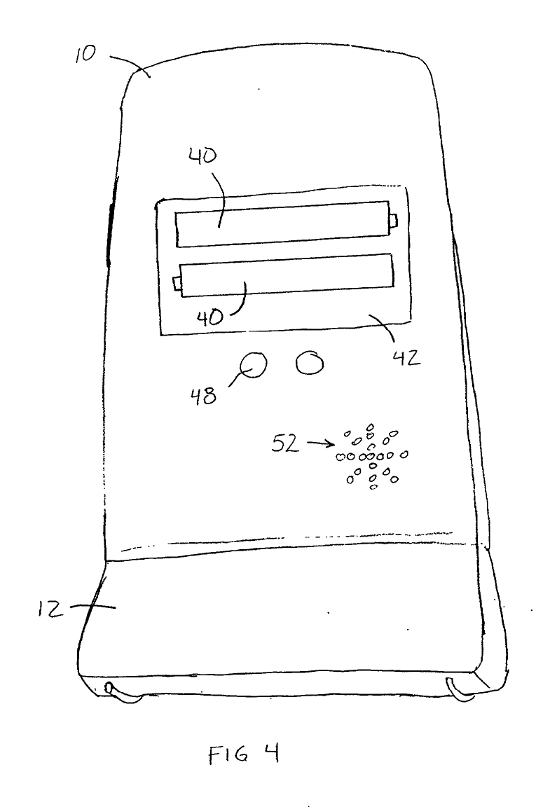

With reference now to FIG. 4, additional weight can also be provided by the addition of a power supply such as a battery 40 disposed within a battery compartment 42. Advantageously, the battery 40 also supplies power to the clock or information display. A button 48 is also provided to adjust the time or the information display 22. Also illustrated is a button 50 which initiates an alarm which sounds through speaker 52 when depressed. Those skilled in the art will also appreciate, that an alarm may alternately be set to a desired time, at which point the alarm will also sound. In yet another embodiment of the invention, the alarm tone is selected to evoke a sense coupled to the image display. For example, devices including an image of a sporting event may employ an alarm tone such as the roar of a crowd, or a particular song associated with the event or team.

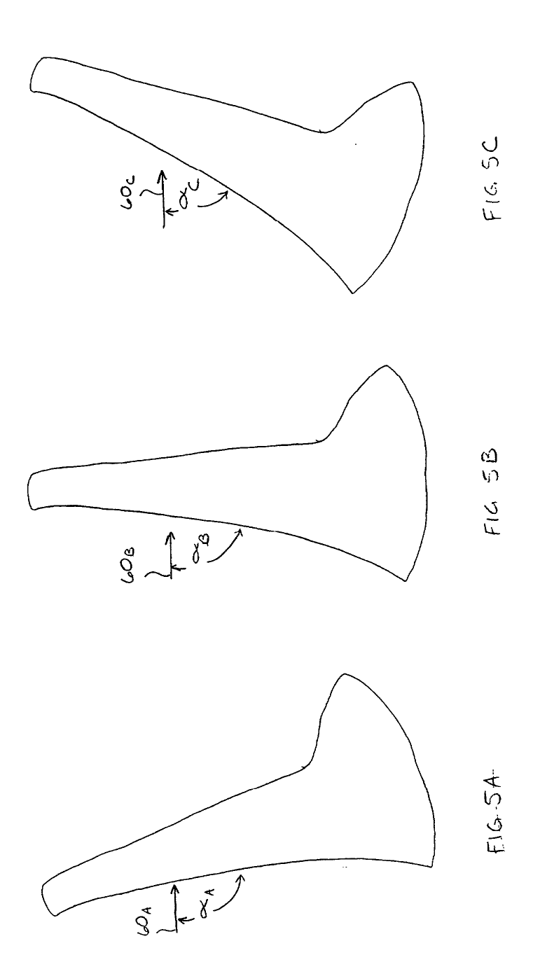

With reference now to FIG. 5, the device is shown in three positions indicative of various locations in the rocking movement. As illustrated, a stationary viewer's line of sight 60ₐ, 60_{b}, 60_{c} remains fixed while the angle of incidence αₐ, α_{b}, α_{c} changes with the devices rocking motion. As is evident now to those of ordinary skill in the art, the changed angle of incidence will correspond to a changed image in the image display 20.

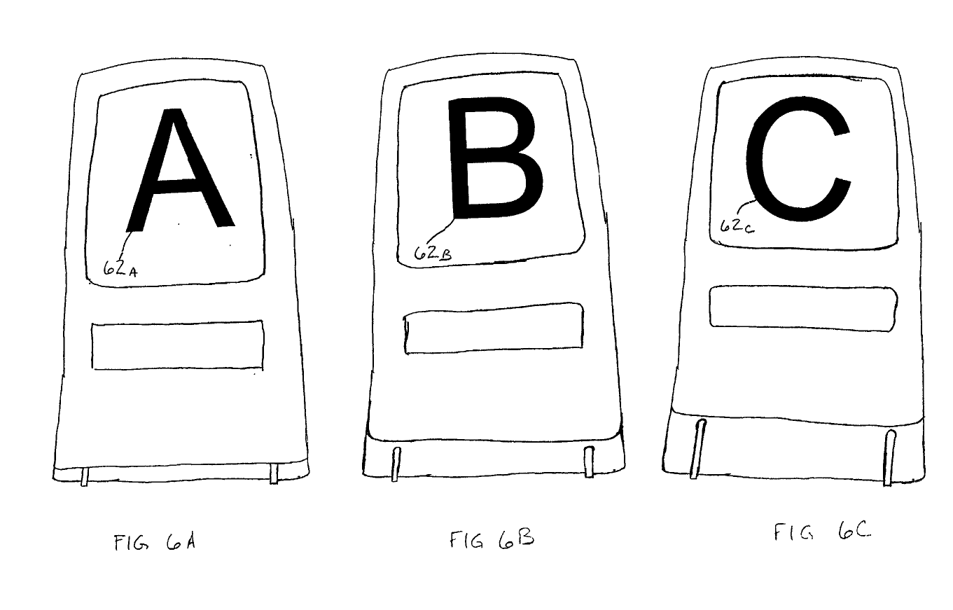

FIG. 6 illustrates various positions during the motion combined with the changing image. As an example, with the different positions of the apparatus in its cycle of motion, the image 62ₐ, 62_{b}, 62_{c} changes.

The invention has been described with reference to the preferred embodiments. Modifications and alterations will occur to others upon reading and understanding the preceding specification. It is intended that the invention be construed as including all such alterations and modifications insofar as they come within the scope of the appended claims or the equivalence thereof.

Having thus set forth the preferred embodiments, the invention is now claimed to be:

1. An apparatus comprising:
an image;
an information display; and
a shaped base portion having a length less than a height of the apparatus;
where the shaped base portion supports the image and the information display in a substantially vertical orientation, the shaped base portion permitting the image and the information display to oscillate upon external urging.

2. The apparatus as set forth in claim 1, where the information display comprises a timepiece.

3. The apparatus as set forth in claim 2, further comprising:
a power supply which provides operative power solely to the timepiece.

4. The apparatus as set forth in claim 1, where the image comprises:
a first image;
a second image; and
a mechanism which displays one of the first and second images depending on a position of oscillation of the shaped base portion.

5. The apparatus as set forth in claim 4, where the mechanism comprises an array of lenticular lenses.

6. The apparatus as set forth in claim 1, where the shaped base portion comprises less than half of a total weight of the apparatus.

7. A clock comprising:
a frame including a top half and a bottom half, the top half including more than fifty per-cent of a total weight of the clock, the bottom half including a rounded base which permits the frame to rock when urged from a static position;
a time indicating display disposed within the frame viewable by an observer; and
an image display disposed within the frame viewable by an observer, the image display alternating between at least two images as the frame rocks.

8. The clock as set forth in claim 7, further comprising:
an alarm settable to sound at a determined time and immediately upon user interaction.

9. The clock as set forth in claim 7, where, following an urge from the static position, the rocking dampens toward the static position.

10. The clock as set forth in claim 7, further comprising a power source for the clock disposed in the top half.

11. A changing display comprising:
a frame including opposed upper and lower sides, where the upper side includes a weight selected to concentrate a higher percentage of weight toward a top of the changing display;
a first image and a second image supported in an upright orientation by the frame;
a image selection mechanism permits viewing of one of the first and second images depending on a viewing angle; and
a non-powered rocking base which supports the frame and permits the viewing angle to change relative to a stationary observer.

12. The changing display as set forth in claim 11, further comprising an information display supported by the frame.

13. The changing display as set forth in claim 12, further comprising a power supply disposed in the frame, the power supply operatively connected to the information display.

14. The changing display as set forth in claim 12, where the weight comprises a power supply operatively connected to the information display.

15. The changing display as set forth in claim 11, where the image selection mechanism comprises a lenticular array.
